(19) United States
(12) Patent Application Publication
(10) Pub. No.: US 2006/0019054 A1
(43) Pub. Date: Jan. 26, 2006

(54) Optical information storage medium

(76) Inventors: Tsai-Chu Hsiao, Chung-Li City (TW); Samuel Fu, Sindian City (TW)

Correspondence Address: BIRCH STEWART KOLASCH & BIRCH, PO BOX 747, FALLS CHURCH, VA, 22040-0747, US

(21) Appl. No.: 10/994,362

(22) Filed: Nov. 23, 2004

(30) Foreign Application Priority Data
Jul. 21, 2004 (TW) 093121823

(51) Int. Cl. B32B 3/02

(52) U.S. Cl. 428/64.4

(57) ABSTRACT

An optical information storage medium includes a first substrate, a first recording layer, a first reflective layer, a spacer layer, a second recording layer, a second reflective layer and a second substrate. In this case, the first recording layer is disposed above the first substrate. The first reflective layer is disposed above the first recording layer. The spacer layer is disposed above the first reflective layer. The second recording layer is disposed above the spacer layer. The second recording layer, which is made of cyanine dye, is disposed above the second recording layer. The second substrate is disposed above the second reflective layer.

### BACKGROUND OF THE INVENTION

1. Field of the Invention

The invention relates to an optical information storage medium, and more particularly to a single side dual layer or dual side dual layer optical information storage medium.

2. Description of the Related Art

With the coming of the information and multimedia age, the demands of the electrical products on the storage density and capacity of the storage medium are constantly increased. The conventional storage media may be generally classified into two kinds, which are magnetic recording media and optical recording media. Currently, the optical recording media, which includes read only memory (CD-ROM), write-once CD (CD-R), rewritable CD (CD-RW), read only memory DVD (DVD-ROM), write-once DVD (DVD-R), rewritable DVD (DVD−RW, DVD+RW), and random memory DVD (DVD-RAM), gets the lager market share.

Increasing the data capacity of the optical disk is a target to be sought in the industry in order to meet the video information quantity that is getting larger and larger. Because the DVD has a larger data storage capacity than the CD does, it has gained a giant share of the market. There are several kinds of DVD, such as single side single layer, dual side single layer, single side dual layer, and dual side dual layer. The storage capacities of these discs range from 4.7 GB to 17 GB.

The 2P process (Photo-Polymerization Process) is one of the frequently used methods for manufacturing the single side dual layer DVD-R disc and the dual side dual layer DVD-R disc. The 2P process will be described with reference to the single side dual layer DVD-R disc 10 as an example.

As shown in FIGS. 1A to 1F describing the 2P process, a first recording layer 121, a first reflective layer 122, and a light-cured adhesive layer 13′ are sequentially formed above a pre-grooved first substrate 11. Next, a pre-grooved stamper 16 is pressed onto the light-cured adhesive layer 13′, and a spacer layer 13 is formed after the layer 13′ is cured by ultra-violet rays. After the stamper 16 is peeled off, at least one groove G is formed on the spacer layer 13, and a second recording layer 141 and a second reflective layer 142 are formed above the spacer layer 13. Finally, the second substrate 15 is bonded to the second reflective layer 142, and the single side dual layer DVD-R disc 10 is thus formed.

Of course, in addition to the single side dual layer DVD-R disc 10, the dual side dual layer DVD-R disc 20 also may be manufactured using the 2P process.

As shown in FIGS. 2A to 2C, the first half of the processes for forming the dual side dual layer DVD-R disc 20 is the same as those of the single side dual layer DVD-R disc 10. A first half disc sequentially has a first substrate 21, a first recording layer 221, a first reflective layer 222, a first spacer layer 23, a second recording layer 241, a second reflective layer 242, according to FIG. 1E. The second half of the disc sequentially has a second substrate 29, a fourth recording layer 282, a fourth reflective layer 281, a third spacer layer 27, a third recording layer 262, a third reflective layer. Next, the two half discs are adhered together using the light-cured adhesive, which forms a second spacer layer 25 after the curing process, and then the manufacturing of the dual side dual layer DVD-R disc 20 is thus completed.

As shown in FIGS. 1A to 1F and FIGS. 2A to 2C, the requirement of data access only can be achieved when the single side dual layer DVD-R disc 10 or the dual side dual layer DVD-R disc 20 has the thickness of 150 nm to 170 nm if the AZO dye serves as the material of the second recording layer 141 or the third recording layer 262 in the prior art. Taking the processes for forming the second recording layer 141 as an example, the pre-grooved stamper 16 and the spacer layer 13 are pressed together and then separated so that the grooves G having a depth of about 160 to 180 nm are formed on the spacer layer 13. Then, the AZO dye is coated onto the grooves G so that the second recording layer 141 having the thickness ranging from 150 nm to 170 nm is formed.

In the prior art, however, the PMMA (Polymethyl Methacrylate) having poor mobility as the material of the stamper 16, and it is difficult to form the stamper 16 having a groove with the depth of about 160 nm. Thus, the desired thickness of the second recording layer 141 is influenced. Hence, the process yield of the discs will be reduced. Consequently, the stamper 16 made of PMMA with poor mobility is not suitable for forming the grooves G required by the second recording layer 141 nor the third recording layer 262 made of the AZO dye. In addition, the adhesive force between the first recording layer 121 and the first reflective layer 122 are relatively weak, and they cannot withstand a large pulling force. Consequently, when the stamper 16 is being peeled off, the spacer layer 13 tends to break and peel off, or even the first recording layer 121 and the first reflective layer 122 are separated from the first substrate 11, as shown in FIG. 3. Furthermore, as the depth of the groove G gets larger, a larger pulling force is required when the stamper 16 is peeled off. In this case, the stamper 16 or the spacer layer 13 tends to be broken and damaged, and the transmitting path of the laser light for accessing data is influenced. Therefore, the disc production yield is low, and the manufacturing cost is increased.

In view of the above-mentioned problems, it is an important subject of the invention to provide an optical information storage medium capable of solving the above-mentioned problems, in which the PMMA stamper cannot form the groove depth required by the second recording layer made of AZO dye in a dual layer digital versatile disc.

### SUMMARY OF THE INVENTION

In view of the foregoing, the invention is to provide an optical information storage medium having a second recording layer made of cyanine dye.

In addition, the invention is to provide an optical information storage medium having a second recording layer made of cyanine dye, and a third recording layer made of cyanine dye.

To achieve the above, an optical information storage medium of the invention includes a first substrate, a first recording layer, a first reflective layer, a spacer layer, a second recording layer, a second reflective layer and a second substrate. The first recording layer is disposed above the first substrate. The first reflective layer is disposed above the first recording layer. The spacer layer is disposed above the first reflective layer. The second recording layer is disposed above the spacer layer. The second recording layer, which is made of cyanine dye, is disposed above the second recording layer. The second substrate is disposed above the second reflective layer.

The invention also provides an optical information storage medium, which includes a first substrate, a first recording layer, a first reflective layer, a first spacer layer, a second recording layer, a second reflective layer, a second spacer layer, a third reflective layer, a third recording layer, a third spacer layer, a fourth reflective layer, a fourth recording layer and a second substrate. In this case, the first recording layer is disposed above the first substrate. The first reflective layer is disposed above the first recording layer. The first spacer layer is disposed above the first reflective layer. The second recording layer is disposed above the first spacer layer, and the second recording layer is made of cyanine dye and disposed above the second recording layer. The second spacer layer is disposed above the second reflective layer. The third reflective layer is disposed above the second spacer layer. The third recording layer is disposed above the third reflective layer, and the third recording layer is made of cyanine dye and disposed above the third recording layer. The fourth reflective layer is disposed above the third spacer layer. The fourth recording layer is disposed above the fourth reflective layer. The second substrate is disposed above the fourth recording layer.

As mentioned above, the optical information storage medium of the invention utilizes the cyanine dye as the material of the second recording layer of the single side dual layer DVD-R disc, and as the materials of the second recording layer and the third recording layer of the dual side dual layer DVD-R disc. Compared to the prior art, because the depth of the groove of the spacer required by the recording layer made of the cyanine dye is smaller in the optical information storage medium of the invention. As a result, the depth of the groove of the stamper for pressing the spacer layer to form the groove is relatively reduced. Because the demand on the depth of the groove is reduced, a cheaper PMMA material may be used to form the stamper by way of injection molding, and the manufacturing cost of the product may be reduced accordingly. In addition, with the decrease of the required depth of the groove of the spacer layer, the pulling force for peeling off the stamper may be reduced, too. Consequently, it is possible to prevent the stamper or other corresponding spacer layer, reflective layer or even recording layer from being damaged, and the product yield may be thus increased.

### BRIEF DESCRIPTION OF THE DRAWINGS

The invention will become more fully understood from the detailed description given herein below illustration only, and thus is not limitative of the present invention, and wherein:

FIGS. 1A to 1F are schematic illustrations showing the manufacturing processes of a conventional single side dual layer digital versatile disc;

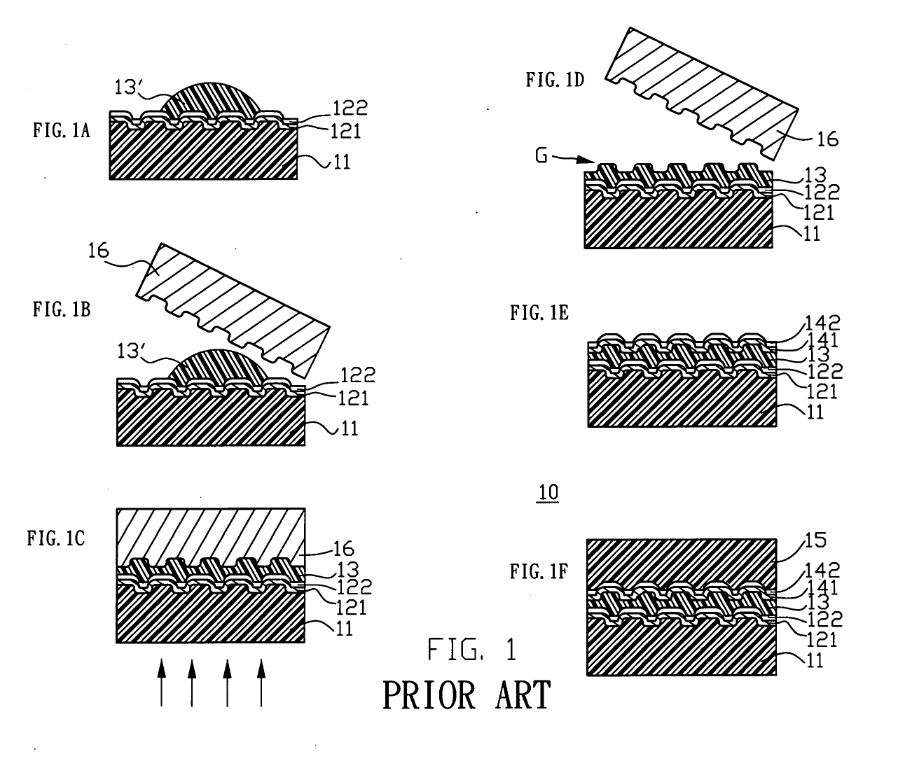

FIGS. 2A to 2C are schematic illustrations showing the manufacturing processes of a conventional dual side dual layer digital video disc;

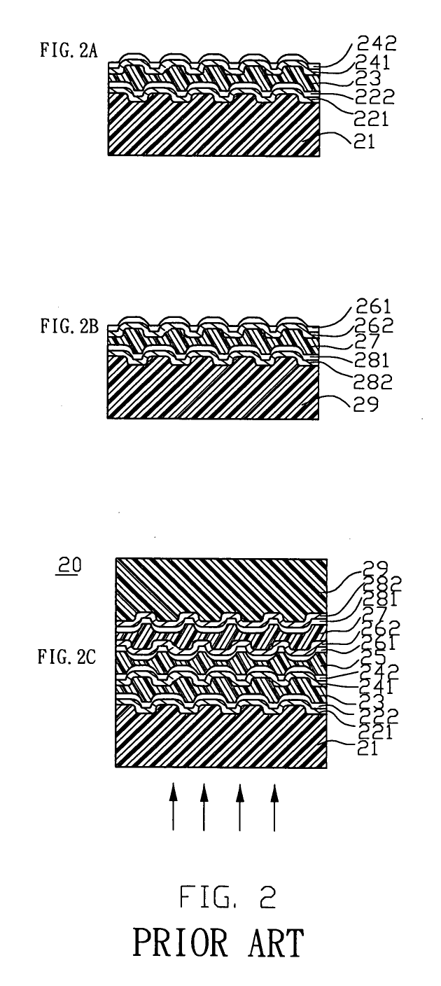

FIG. 3 is a schematic illustration showing the manufacturing process of a conventional single side dual layer digital versatile disc, wherein the spacer layer or stamper is damaged when the stamper is peeled off;

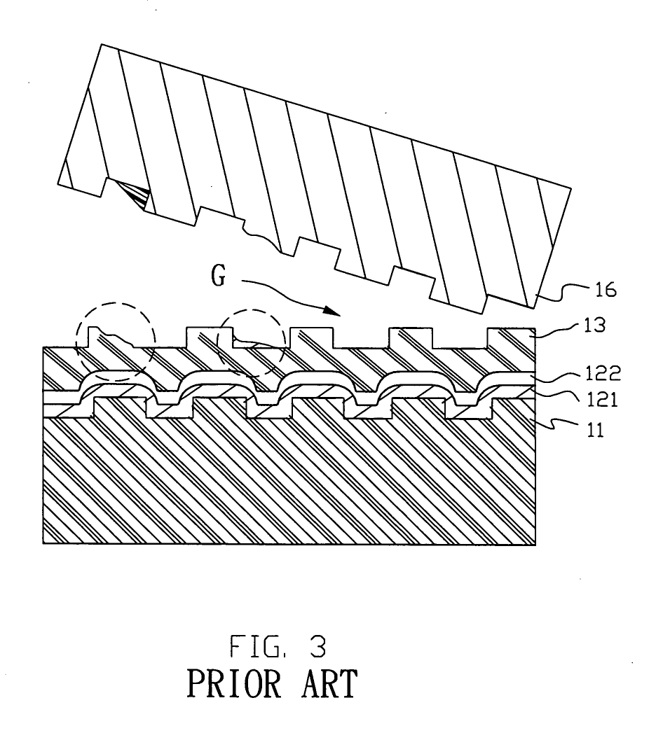

FIG. 4 is a schematic illustration showing an optical information storage medium according to a first preferred embodiment of the invention, wherein the optical information storage medium is a single side dual layer digital video disc; and

FIG. 5 is a schematic illustration showing an optical information storage medium according to a second preferred embodiment of the invention, wherein the optical information storage medium is a dual side dual layer digital versatile disc.

### DETAILED DESCRIPTION OF THE INVENTION

The optical information storage media according to the preferred embodiments of the invention will be described with reference to the accompanying drawings.

The optical information storage medium of the invention is manufactured by the 2P process (Photo-Polymerization Process). The optical information storage medium can be a write once single side dual layer digital versatile disc, or a write once dual side dual layer digital versatile disc.

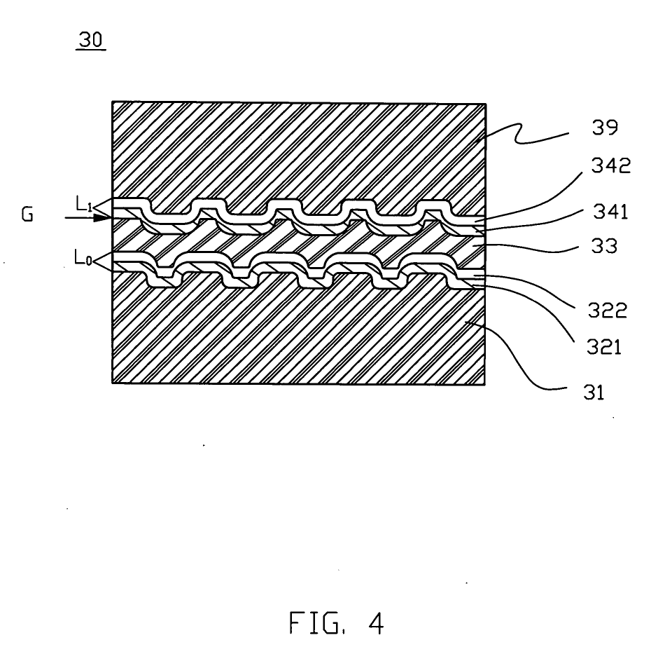

The optical information storage medium according to the first preferred embodiment of the invention will be described with reference to FIG. 4.

Referring to FIG. 4, the single side dual layer DVD-R disc 30 includes a first substrate 31, a first recording layer 321, a first reflective layer 322, a spacer layer 33, a second recording layer 341, a second reflective layer 342 and a second substrate 39.

The first recording layer 321 and the first reflective layer 322 may be referred to as a first recording stack L₀, and the second recording layer 341 and the second reflective layer 342 may be referred to as a second recording stack L₁. The laser light enters the disc from the first recording stack L₀ side.

The frequently used material of the first substrate 31 and the second substrate 39 is the polycarbonate (PC), which has good optical property and good chemical stability. In this embodiment, the first substrate 31 and the second substrate 39 are made of polycarbonate and are injection molded into pre-grooved substrates.

The first recording layer 321 is disposed above the first substrate 31. The material of the first recording layer 321 may be the organic dye or inorganic material. In this embodiment, the material of the first recording layer 321 is the organic dye, and the first recording layer 321 is formed by spin coating.

The first reflective layer 322 is disposed above the first recording layer 321 an the first reflective layer 322 is a semi-reflective layer made of the material of pure metal or the alloy thereof, such as the silver or silver alloy, the aluminum or aluminum alloy, and the gold or the gold alloy. The first reflective layer 322 is usually formed by sputtering or evaporation.

The spacer layer 33 is disposed above the first reflective layer 322. During the formation of the spacer layer 33, a liquid light-cured adhesive is coated, and then a pre-grooved soft stamper is pressed onto the light-cured adhesive. After exposed to the ultra-violet ray, the light-cured adhesive is cured into a solid spacer layer 33, which can distinguish the light rays reflected by different recording layers. In this case, the groove depth of the soft stamper is about 100 to 150 nm.

Consequently, the spacer layer 33 at least has one groove pattern G facing the second recording layer 341, and the groove pattern G has a depth of about 100 to 150 nm. In this embodiment, the material of the soft stamper for forming the groove pattern G may be the PMMA (Polymethyl Methacrylate).

The second recording layer 341 is disposed above the spacer layer 33 and the second recording layer 341 is made of cyanine dye by coating. The thickness of the second recording layer 341 is about 110 to 140 nm. Thus, the required depth of the groove pattern G of the spacer layer 33 is smaller than that of the AZO dye (the AZO dye needs the groove depth of about 160 nm, and the cyanine dye only needs the groove depth of about 120 nm).

The second reflective layer 342 is disposed above the second recording layer 341, and the second reflective layer 342 may be made of the inorganic material. The material of the second reflective layer 342 may be a semi conductive alloy film, a conductive alloy film, or a metal film.

The second substrate 39 is disposed above the second reflective layer 342, and may be adhered to the second reflective layer 342 using an adhesive.

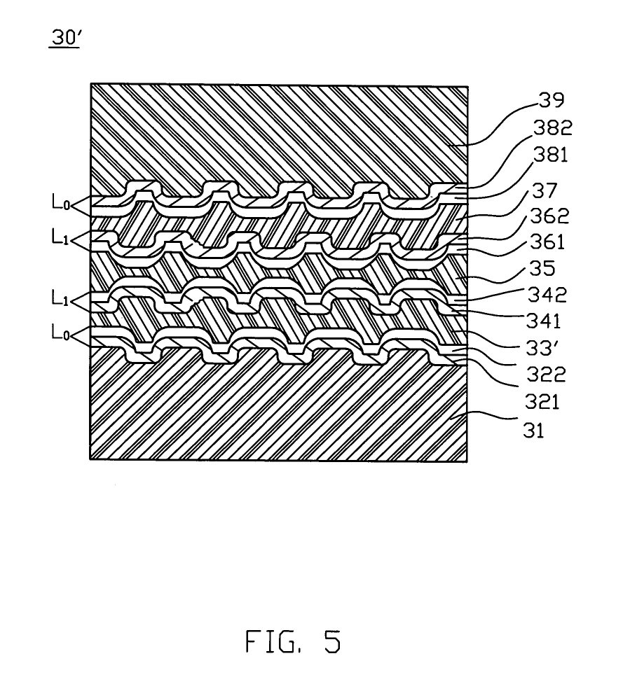

The optical information storage medium according to the second preferred embodiment of the invention will be described with reference to FIG. 5.

The dual side dual layer DVD-R disc 30′ includes a first substrate 31, a first recording layer 321, a first reflective layer 322, a first spacer layer 33′, a second recording layer 341, a second reflective layer 342, a second spacer layer 35, a third reflective layer 361, a third recording layer 362, a third spacer layer 37, a fourth reflective layer 381, a fourth recording layer 382 and a second substrate 39.

Because the laser light may enter the disc from two sides of the substrate, the first recording layer 321 and the first reflective layer 322 may be referred to as the first recording stack L₀, and the fourth reflective layer 381 and the fourth recording layer 382 also may be referred to as the first recording stack L₀. In addition, the second recording layer 341 and the second reflective layer 342 are referred to as the second recording stack L₁, and the third reflective layer 361 and the third recording layer 362 also may be referred to as the second recording stack L₁.

The first recording layer 321 is disposed above the first substrate 31, the first reflective layer 322 is disposed above the first recording layer 321, the first spacer layer 33′ is disposed above the first reflective layer 322, the second recording layer 341 is disposed above the first spacer layer 33′, the second recording layer 341 is made of cyanine dye, and the second reflective layer 342 is disposed above the second recording layer 341.

In this embodiment, the functions and features of the first substrate 31, the first recording layer 321, the first reflective layer 322, the first spacer layer 33′, the second recording layer 341 and the second reflective layer 342 are respectively the same as the first substrate 31, the first recording layer 321, the first reflective layer 322, the spacer layer 33, the second recording layer 341 and the second reflective layer 342 of the first embodiment of the invention, and detailed descriptions thereof will not be repeated.

The third reflective layer 361 is disposed above the second spacer layer 35, the third recording layer 362 is disposed above the third reflective layer 361, and the third recording layer 362 is made of cyanine dye. In this embodiment, the third reflective layer 361 and the second reflective layer 342 may be made of the same material, and the third recording layer 362 and the second recording layer 341 may be made of the same material. Because the cyanine dye cannot withstand too much light, the second recording stack L₁ of the disc can reduce the light intensity to the cyanine dye.

The second spacer layer 35 is disposed above the second reflective layer 342 and the third spacer layer 37 is disposed above the third recording layer 362. In this embodiment, each of the second spacer layer 35 and the third spacer layer 37 may be formed by curing a light-cured adhesive. The materials of the second spacer layer 35 and the third spacer layer 37 may be the same as that of the first spacer layer 33′, and detailed descriptions thereof will be omitted.

The fourth reflective layer 381 is disposed above the third spacer layer 37, and the fourth recording layer 382 is disposed above the fourth reflective layer 381. The material of the fourth reflective layer 381 may be the same as that of the first reflective layer 322, and each of the fourth reflective layer 381 and the first reflective layer 322 is a semi-reflective layer.

The second substrate 39 is disposed above the fourth recording layer 382. In this embodiment, the material of the second substrate 39 may be the same as that of the first substrate 31.

As mentioned above, the optical information storage medium of the invention utilizes the cyanine dye as the material of the second recording layer of the single side dual layer DVD-R disc, and as the materials of the second recording layer and the third recording layer of the dual side dual layer DVD-R disc. Compared to the prior art, because the depth of the groove of the spacer required by the recording layer made of the cyanine dye is smaller in the optical information storage medium of the invention, the depth of the groove of the stamper for pressing the spacer layer to form the groove is relatively reduced. Because the demand on the depth of the groove is reduced, a cheaper PMMA material may be used to form the stamper by way of injection molding, and the manufacturing cost of the product may be reduced accordingly. In addition, with the decrease of the depth of the groove of the spacer layer, the pulling force for peeling off the stamper away may be reduced. Consequently, it is possible to prevent the stamper or other corresponding spacer layer, reflective layer or even recording layer from being damaged, and the product yield may be thus increased.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. An optical information storage medium, comprising:
a first substrate;
a first recording layer disposed above the first substrate;
a first reflective layer disposed above the first recording layer;
a spacer layer disposed above the first reflective layer;
a second recording layer, which is made of cyanine dye and disposed above the spacer layer;
a second reflective layer disposed above the second recording layer; and
a second substrate disposed above the second reflective layer.

2. The optical information storage medium according to claim 1, wherein the optical information storage medium is a write once single side dual layer digital versatile disc.

3. The optical information storage medium according to claim 1, wherein the optical information storage medium is manufactured by a 2P process (Photo-Polymerization Process).

4. The optical information storage medium according to claim 1, wherein the first reflective layer is a semi-reflective layer.

5. The optical information storage medium according to claim 1, wherein the spacer layer is formed with at least one groove facing the second recording layer.

6. The optical information storage medium according to claim 5, wherein the groove has a depth of about 100 to 150 nm.

7. The optical information storage medium according to claim 5, wherein the groove is formed by a soft stamper.

8. The optical information storage medium according to claim 7, wherein the soft stamper is made of PMMA (Polymethyl Methacrylate).

9. The optical information storage medium according to claim 1, wherein the second recording layer has a thickness of about 110 to 140 nm.

10. An optical information storage medium, comprising:
a first substrate;
a first recording layer disposed above the first substrate;
a first reflective layer disposed above the first recording layer;
a first spacer layer disposed above the first reflective layer;
a second recording layer, which is made of cyanine dye and disposed above the first spacer layer;
a second reflective layer disposed above the second recording layer;
a second spacer layer disposed above the second reflective layer;
a third reflective layer disposed above the second spacer layer;
a third recording layer, which is made of cyanine dye and disposed above the third reflective layer;
a third spacer layer disposed above the third recording layer;
a fourth reflective layer disposed above the third spacer layer;
a fourth recording layer disposed above the fourth reflective layer; and
a second substrate disposed above the fourth recording layer.

11. The optical information storage medium according to claim 10, wherein the optical information storage medium is a write once dual side dual layer digital versatile disc.

12. The optical information storage medium according to claim 10, wherein the first reflective layer is a semi-reflective layer.

13. The optical information storage medium according to claim 10, wherein the fourth reflective layer is a semi-reflective layer.
